(19) United States
(12) Patent Application Publication
(10) Pub. No.: US 2002/0158897 A1
(43) Pub. Date: Oct. 31, 2002

(54) System for displaying topology map information through the web

(76) Inventors: Lawrence M. Besaw, Ft Collins, CO (US); John C. Adams, Westminster, CO (US)

Correspondence Address: HEWLETT-PACKARD COMPANY, Intellectual Property Administration, P.O. Box 272400, Fort Collins, CO, 80527-2400, US

(21) Appl. No.: 09/843,887

(22) Filed: Apr. 30, 2001

(51) Int. Cl. G06F 13/00

(52) U.S. Cl. 345/734

(57) ABSTRACT

A system for providing a topology map generation service from a service information portal is improved by utilizing an object-oriented class, a mapview module, configured for generating topology maps. The mapview module may be implemented in an object-oriented language such as Smalltalk, C++, JAVA or the like. The mapview module may be configured to provide member functions that include at least associating an output file stream; adding icon symbols and connections symbols between the icon symbols; generating a background graphic (e.g., a building, a geographic map, etc.,); and generating a topology map (or image) by calling a command on an object; and utilizing hypertext transfer protocol (“HTTP”) to transfer images across a network. In effect, the mapview module hides all the low-level graphic details for generating a topology view/map/image from a user. Thus, the generation of the topology maps may become easier. Additionally, since the mapview module is an object-oriented class, the mapview module may be used on a variety of computing platforms and support multiple graphic formats such as graphics interchange format (“GIF”), portable network graphics (“PNG”) and the like.

### FIELD OF THE INVENTION

This invention relates generally to object oriented computer programming, and more particularly to generating topology maps over a network utilizing an object-oriented class to provide topology map generation services.

### DESCRIPTION OF THE RELATED ART

Network communications have become a fundamental part of today's computing. It is not uncommon to find two or more computer systems working together to resolve issues such as simulations, modeling, forecasting, etc. In fact, these efforts have been so successful, users have been inclined to design and implement larger and more powerful networks.

As the networks grow larger, increasingly complex, and interface with a variety of diverse networks, it is the task of a network manager (or administrator/user) to keep track of the devices on the networks, to monitor performances and load, to diagnose, and to correct problems with the network.

To assist a network manager, network management software (“NMS”) is typically used in the management of a network. The conventional NMS is typically executed on a management device or node of the network. From the management node, the conventional NMS is configured to determine a network topology, detect malfunctioning remote network devices or communication links, monitor network traffic, etc.

As part of the monitoring duties, the network manager may configure the NMS to occasionally display topology maps. The topology maps may be configured to display network nodes, links between network nodes, etc. Typically, the topology maps are created by a display module when a user invokes a display command within the NMS. The display module generates the requested topology maps by passing arguments and/or data to a graphics library. The graphics library may contain program code to generate single elements that are combined to create the requested topology map, which are invoked by the display module to create the requested topology map.

However, the use of a graphic library may restrict the type of graphical data formats, e.g., graphics interchange format (“GIF”), portable network graphics (“PNG”), etc., that may be supported by the NMS. Typically, each graphical data format requires a respective graphics library for support. Accordingly, to support multiple graphical data formats, the programmer(s) of the NMS may be forced to include multiple graphical libraries. Moreover, the difficulty of supporting multiple graphical data format may be compounded if developers of the NMS desire to convert from one graphic format to another. As a result, the NMS may become larger, thereby increasing the hardware support costs of the NMS.

Moreover, the generation of topology maps are typically requested within a small network. However, as networks increasingly get larger, attempting to provide similar graphic capability may become more difficult. For instance, JAVA applets may be used to generate topology maps for requesting users of an NMS. A JAVA applet is an application that may be configured to generate a topology map on a remote user's computer. However, firewalls, network security devices and the like, may prevent the transfer of the JAVA applet to a remote user's computer, thereby preventing the generation of a topology map.

### SUMMARY OF THE INVENTION

In accordance with the principles of the present invention, a method of generating network topology maps includes receiving a map request from a remote node and invoking a class configured to generate a topology map with gathered information. The method also includes transmitting the topology map to the remote node using a network protocol.

In accordance with another aspect of the principles of the present invention, a system for generating network topology maps includes at least one processor, a memory coupled to said at least one processor, and a topology map module. The topology map resides in the memory and is executed by at least one processor. The topology map module is configured to receive a map request from a remote node, invoke a class configured to generate a topology map with gathered information; and to transmit the topology map to the remote node using a network protocol.

In accordance with another aspect of the principles of the present invention, a computer readable storage medium is embedded with one or more computer programs. The one or more computer programs implement a method of generating a network topology map image. The one or more computer programs includes a set of instructions for receiving map request from a remote node, invoking a class configured to generate a topology map with gathered information; and transmitting the topology map to the remote node using a network protocol.

### BRIEF DESCRIPTION OF THE DRAWINGS

FIG. 1 illustrates a system where an exemplary embodiment of the present invention may be practiced therein;

FIG. 2 illustrates a detailed block diagram of an exemplary embodiment according to the principles of the present invention;

FIG. 3 illustrates an exemplary computer system where an embodiment of the present invention may be practiced;

FIG. 4 illustrates a more detailed software architecture diagram of the topology map module with an exemplary embodiment of a mapview module in accordance with the principles of the present invention; and

FIG. 5 illustrates an exemplary flow diagram of the topology map module invoking the mapview module in accordance with the principles of the present invention.

### DETAILED DESCRIPTION OF A PREFERRED EMBODIMENT

For simplicity and illustrative purposes, the principles of the present invention are described by referring mainly to an exemplary embodiment of a service provided by a service information portal. However, one of ordinary skill in the art would readily recognize that the same principles are equally applicable to all types of graphic generation over a network, and can be implemented in any network and in any communication protocols, and that any such variation would be within such modifications that do not depart from the true spirit and scope of the present invention.

According to a disclosed embodiment of the present invention, a system for providing a topology map generation service from a service information portal is improved by utilizing a mapview module configured for generating topology maps. The mapview module may be implemented in an object-oriented language such as Smalltalk, C++, JAVA, or the like. The mapview module may be configured to provide member functions that include at least associating an output file stream; adding icon symbols and connections symbols between the icon symbols; generating a topology map (or image) by calling a command on an object; generating a background graphic (e.g., a building, a geographic map, etc.,); and utilizing a protocol such as hypertext transfer protocol(“HTTP”), HTTP secure socket layer (“HTTPS”) protocol, etc., to transfer images across a network. In effect, the mapview module may hide the low-level graphic details for generating a topology view/map/image from a user, i.e., the mapview module provides a layer of abstraction. Thus, the generation of the topology maps may become easier. Additionally, the mapview module may be used on a variety of computing platforms and support multiple graphic formats such as GIF, PNG and the like.

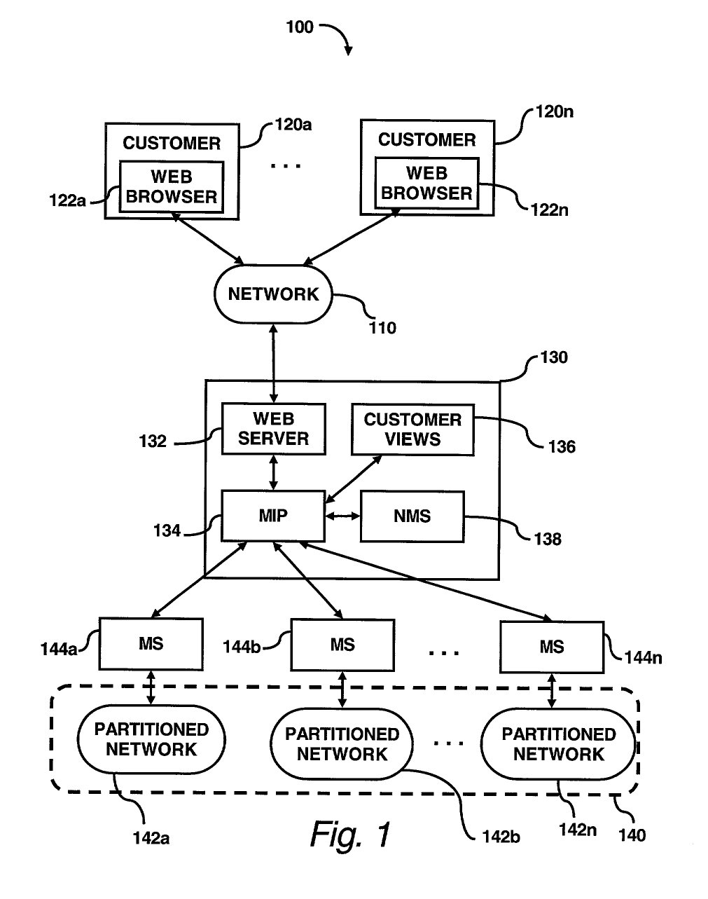

FIG. 1 illustrates a system 100 where an exemplary embodiment of the present invention may be practiced. As shown in FIG. 1, the system 100 includes at least a network 110 interfaced between customers 120 and a management portal 130. The network 110 may be may be implemented as a local area network, a wide area network, a wireless network, Internet or the like. Although, in the exemplary embodiment, the network 110 may utilize a hypertext transfer protocol (“HTTP”) to provide communication services between the customers 120 and the service provider 130, a variety of other network protocols (TCP/IP, X.25, etc.,) may also be used to provide communication services.

Although, for illustrative purposes, only one network 110 is shown in FIG. 1, it should be understood and readily apparent to those familiar with networks that there may be any number of networks interfacing customers 120 and the management portal 130.

A service provider may offer a variety of network services to customers 120. The customer 120 may be a management information system group, a network administrator, a corporation, an organization, etc. The network services may include Internet services, electronic mail (e-mail) services, network management service, and the like. A customer may not prefer to create and/or manage a network to provide network services, which may be driven by a lack of expertise, cost, etc. In order to receive network services, the customer may utilize the service provider to provide the desired network services. The service provider would then configure a portion of its own network 140 into partitioned networks 142, and each partition network 142 is allocated to a customer 120.

The service provider may utilize the management portal 130 to provide management services to the customers 120. As one of the services, the service provider may configure the management portal 130 to provide the capability for a customer to view relevant information of the customer's partitioned network in a topological map on a hypertext markup language (“HTML”) document, XML, or the like, i.e., a web page.

To request and view a topological map, a customer 120a may invoke a web browser 122a, e.g., the NAVIGATOR from the Netscape Communications Corporation of Mountain View, Calif., USA, or the INTERNET EXPLORER from the Microsoft Corporation of Redmond, Wash., USA. The web browser 122a of the customer 120a may contact a web server 132 of the management portal 130. The web server 132 may be at least configured to provide authentication services for the customer 120a to provide security services for the customers 120.

Once authenticated, a customer 120a may be given access to a management information portal 134 of the management portal 130. The management information portal 134 may be configured to provide customized management services to the customers 120 by referencing a customer views module 136. The customer views module 136 may be configured to maintain a database of the types of services available to each customer in response to being authenticated into the management portal 130.

The management information portal 134 may be further configured to interface with a network management software (“NMS”) 138. The NMS 138 may be configured to provide network management services such as monitoring, diagnosis, and correction to the management information portal 134.

The management information portal 134 may be further configured to interface with management stations 144. The management stations 144 may be configured to provide a management node function for each of the partitioned networks 142.

The management information portal 134 may be configured to provide a service of generating topology network maps for a customer. The topology network map may be configured to show various aspects of the customer's partitioned network 142 as provided by the service provider.

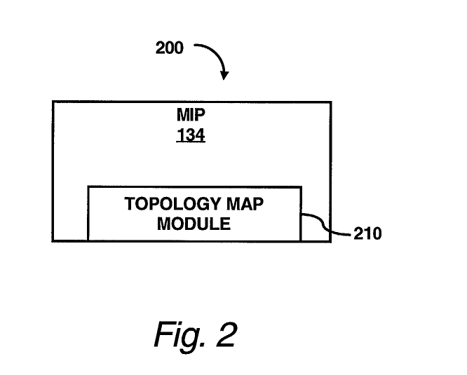

FIG. 2 illustrates a more detailed block diagram 200 of an exemplary embodiment of the management information portal 134 according to the principles of the present invention. In particular, the management information portal 134 may be at least configured to interface with a topology map module 210. The topology map module 210 may be configured to provide customers requested topology maps. For example, when a customer (or user) requests a topology map, the topology map module 210 may be configured to invoke a mapview module to generate the requested topology map. The mapview module may be further configured to include icon symbols representing network nodes on the generated topology may and show connection lines between the placed icon symbols. The topology map module 210 may be further configured to associate the requested topology map with the output file stream to transport the requested topology map to the network node utilizing a protocol such as the HTTP protocol, the HTTPS protocol and the like. Accordingly, by using a protocol such as HTTP protocol, the topology maps may be linked into a web page and stored encrypted. The topology maps may then pass through network firewalls when a user activates the link for the topology maps.

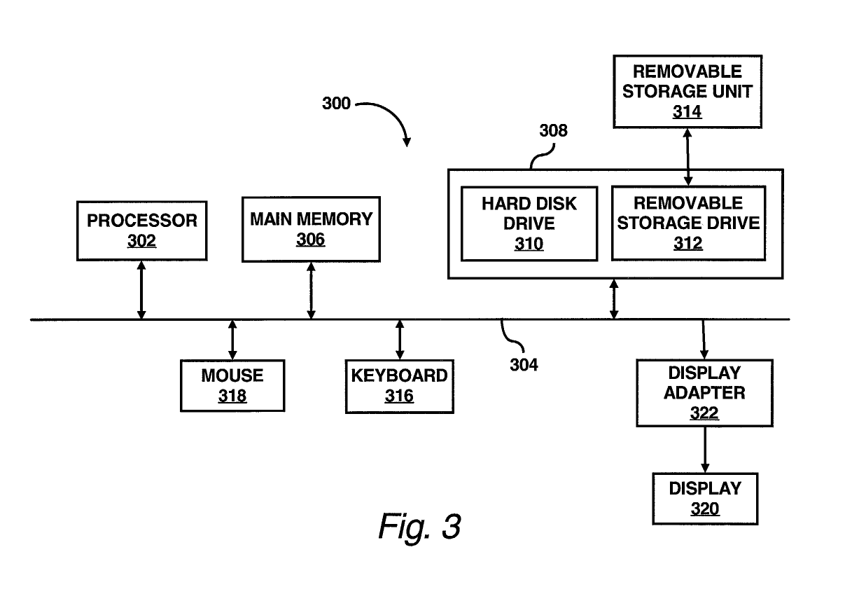

FIG. 3 illustrates an exemplary computer system 300 of one embodiment of the present invention. The functions of the management information portal 134 are preferably implemented in program code and executed by the computer system 300. In particular, the computer system 300 includes one or more processors, such as a processor 302 that provides an execution platform for the management information portal 134. Commands and data from the processor 302 are communicated over a communication bus 304. The computer system 300 also includes a main memory 306, preferably Random Access Memory (RAM), where the software for the management information portal 134 is executed during runtime, and a secondary memory 308. The secondary memory 308 includes, for example, a hard disk drive 310 and/or a removable storage drive 312, representing a floppy diskette drive, a magnetic tape drive, on a compact disk drive, etc., where a copy of software for the management information portal 134 may be stored. The removable storage drive 312 reads from and/or writes to a removable storage unit 314 in a well-known manner. A user from the service provider may interface directly with the management information portal 134 with a keyboard 316, a mouse 318, and a display 320. A display adaptor 322 interfaces with the communication bus 304 to receive display data from the processor 302 and converts the display data into display commands for the display 320.

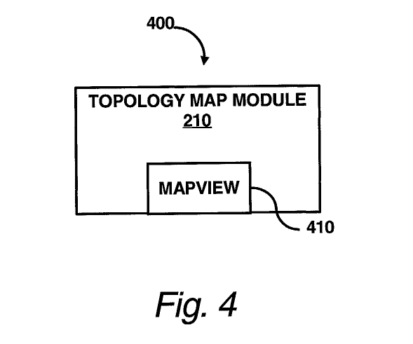

FIG. 4 illustrates a more detailed software architecture diagram 400 of the topology map module 210 with an exemplary embodiment of a mapview module 410 in accordance with the principles of the present invention. In particular, the topology map module 210 may be interfaced with a mapview module 410. The mapview module 410 may be configured to provide a layer of abstraction between the topology module 210 and a supplied graphics library. The mapview module 410 may make a system call for the supplied graphics library, e.g., libgd, to generate a topology map in the appropriate graphics format, e.g., GIF, PNG, etc. For example, the mapview module 410 may initialize a graphics driver as one of its member functions. The graphics driver class may represent any supplied graphics library that the programmer of the NMS may support. Thus, the mapview module 410 may provide an abstraction layer between the user and the graphics library. Accordingly, the programmer of the NMS may support multiple graphics library and multiple graphics format without increasing the cost of implementation.

The mapview module 410 may be further configured to provide member functions that include at least associating an output file stream; adding icon symbols and connections symbols between the icon symbols; generating a background graphic (e.g., a building, a geographic map, etc.,); and generating a topology map (or image) by calling a command on an object; and utilizing a transfer protocol such as HTTP, HTTPS, and the like to transfer images across a network to the topology map module 210.

The topology map module 210 may receive a request for a network topology map as a service provided by the management information portal 134 (shown in FIG. 1). The topology map module 210 may be configured to provide a customer a display of possible topology maps that may be generated for a customer's network. Alternatively, the topology map module 210 may be configured to display a list of filters or filtering functions that may be applied to the customer's network to generate a requested network topology map.

Once the requested network topology map is selected, the topology map module 210 gathers the appropriate information to generate the requested topology map. The topology map module 210 invokes the mapview module 410 in response to a completion of the information gathering. Alternatively, the topology map module 210 may pass the gathered information, as gathered, to the mapview module 410. Additionally, a customer may prefer to include icons representing network nodes with connection lines representing the physical links between the network nodes and icons and/or connection lines may be included in the gathered information.

The mapview module 410 may generate the requested topology map by invoking member functions on the gathered information. Additionally, one of the member functions provides that the generated topology map be transferred to the user by associating an output file stream. The output file stream may be configured to transfer the topology map utilizing a protocol such as the HTTP protocol, HTTPS protocol, etc.

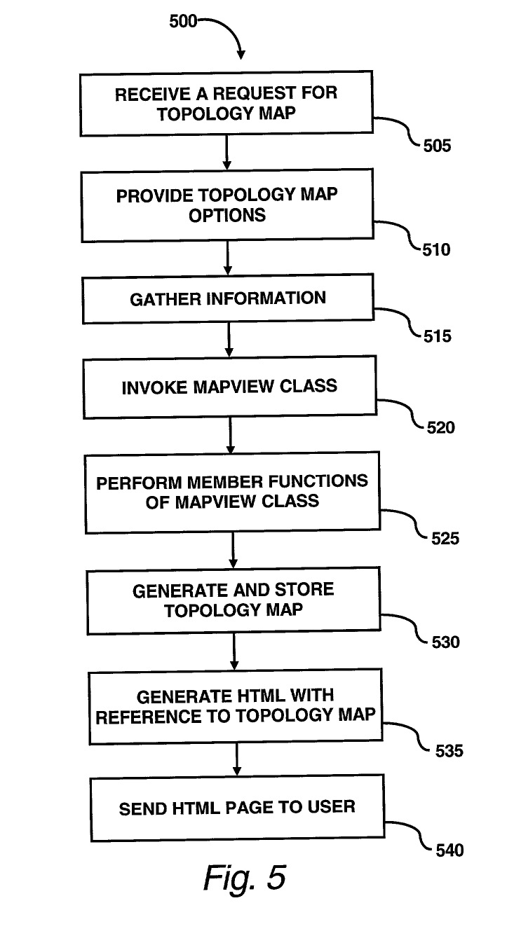

FIG. 5 illustrates an exemplary flow diagram 500 of the topology map module 210 invoking the mapview module 410 in accordance with the principles of the present invention. In particular, in step 505, the topology map module 210 may be configured to receive a request to generate a topology map from a customer 120, as described herein above. The topology map module 210 may be further configured to display a list of topology map options for the requested topology map, in step 510. The topology map options may include a list of parameters such as performance attributes, status, throughput and the like. By enabling one or more of the topology map options, a filtering process may be applied to reduce the amount of information presented to the user, thereby creating a customized topology map for the user.

In step 515, the topology map module 210 may be configured to gather the appropriate information as filtered by the topology map options. The topology map module 210 may be further configured to invoke the mapview module 410 with the gathered information creating a mapview object, in step 520.

In step 525, the mapview object may be configured to perform the member functions of the mapview module 410 to generate the requested topology map. The requested topology map may be stored in a memory location allocated by the management portal 130 (as shown in FIG. 2) in a graphics format selected by the customer, in step 530.

In step 535, the topology map module 210 may be further configured to generate a web page with a hypertext link (or reference, uniform resource locator, etc.,) of the stored topology map. The web page is then forwarded over the network 110 (as shown in FIG. 1) to the user of the network node 220, in step 540.

Accordingly, a user may display the requested topology map by opening the forwarded web page with a web browser. As the web browser parses the forwarded web page, an attribute, e.g., HREF, in the hypertext link invokes a common gateway interface (“CGI”) in the management portal 130 to transport the stored topology map to the customer using a protocol such as the HTTP or HTTPS protocol.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method for generating a network topology map, comprising:
receiving a map request from a remote node;
invoking a mapview module configured to generate a topology map with gathered information; and
transmitting said topology map to said remote node using a network protocol.

2. The method for generating a network topology map according to claim 1, further comprising:
adding a plurality of icons to said topology map, wherein said mapview module is further configured to generate connection lines between a subplurality of icons of said plurality of icons.

3. The method for generating a network topology map according to claim 1, further comprising:
associating an output file stream with said topology map transmitted to said remote node.

4. The method for generating a network topology map according to claim 1, further comprising:
generating said topology map by receiving a command on said gathered information.

5. The method for generating a network topology map according to claim 1, further comprising:
initializing a graphics driver, said graphics driver configured to provide an abstraction layer between said mapview module and a graphics library.

6. The method for generating a network topology map according to claim 5, further comprising:
formatting said topology map to conform to a graphics format supported by said graphics library, wherein said graphics format includes a portable network graphics (“PNG”) format.

7. The method for generating a network topology map according to claim 5, further comprising
formatting said topology map to conform to a graphics format supported by said graphics library, wherein said graphics format includes a graphics interchange format (“GIF”).

8. The method for generating a network topology map according to claim 1, wherein said network protocol includes hypertext transfer protocol.

9. A system for generating a network topology map, said system comprising:
at least one processor;
a memory coupled to said at least one processor;
a topology map module residing in said memory and executed by said at least one processor, wherein said topology map module is configured to receive a map request from a remote node, invoke a mapview module configured to generate a topology map with gathered information; and to transmit said topology map to said remote node using a network protocol.

10. The system for generating a network topology map according to claim 9, wherein said mapview module is further configured to add a plurality of icons to said topology map and to generate connection lines between a subplurality of icons of said plurality of icons.

11. The system for generating a network topology map according to claim 9, wherein said mapview module is further configured to associate an output file stream with said topology map transmitted to said remote node.

12. The system for generating a network topology map according to claim 9, wherein said mapview module is further configured to generate said topology map by initiating a command on said gathered information.

13. The system for generating a network topology map according to claim 9, wherein said mapview module is further configured to generate said topology map in a portable network graphics (“PNG”) format.

14. The system for generating a network topology map according to claim 9, wherein said mapview module is further configured to generate said topology map in a graphics interchange format (“GIF”).

15. A computer readable storage medium on which is embedded one or more computer programs, said one or more computer programs implementing a method for generating a network topology map, and comprising a set of instructions for:
receiving map request from a remote node;
invoking a mapview module configured to generate a topology map with gathered information; and
transmitting said topology map to said remote node using a network protocol.

16. The computer readable storage medium in according to claim 15, said one or more computer programs further comprising a set of instructions for:
adding a plurality of icons to said topology map, wherein said mapview module is further configured to generate connection lines between a subplurality of icons of said plurality of icons.

17. The computer readable storage medium in according to claim 15, said one or more computer programs further comprising a set of instructions for
associating an output file stream with said topology map to said remote node.

18. The computer readable storage medium in according to claim 15, said one or more computer programs further comprising a set of instructions for
generating said topology map by initiating a command on said gathered information.

19. The computer readable storage medium in according to claim 15, said one or more computer programs further comprising a set of instructions
formatting said topology map to conform with a portable network graphics (“PNG”) format.

20. The computer readable storage medium in according to claim 15, said one or more computer programs further comprising a set of instructions
formatting said topology map to conform with a graphics interchange format (“GIF”).
